(19) United States
(12) Patent Application Publication
(10) Pub. No.: US 2016/0258868 A1
(43) Pub. Date: Sep. 8, 2016

(54) NON-MIGRATORY PHOTOACTIVE DIOLS FOR FLUORESCENT POLYMERS

(71) Applicant: BASF SE, Ludwigshafen (DE)

(72) Inventors: Eric Calhoun, Wyandotte, MI (US); David Trumbo, Waukesha, WI (US)

(21) Appl. No.: 14/897,037

(22) PCT Filed: Jun. 6, 2014
(86) PCT No.: PCT/US14/41292

§ 371 Date: Dec. 9, 2015

Related U.S. Application Data
(60) Provisional application No. 61/833,740, filed on Jun. 11, 2013.

(51) Int. Cl. G01N 21/64; C08G 18/08; C08G 18/38

(52) U.S. Cl. CPC G01N 21/64; C08G 18/3848; C08G 18/14

(57) ABSTRACT

A polyurethane foam includes a fluorescent repeating unit. The authenticity of a polyurethane foam may be determined by irradiating the foam with a UV light and determining if there is a fluorescent emission.

### CROSS-REFERENCE TO RELATED APPLICATIONS

This application claims the benefit of priority to U.S. Provisional Patent Application 61/833,740, filed on Jun. 11, 2013, which is incorporated herein by reference in its entirety.

### FIELD

The present technology is generally related to polymers. More specifically it is related to polymers having monomeric repeat units that exhibit fluorescence.

### SUMMARY

In one aspect, a polyurethane foam is provided having a fluorescent monomeric repeat unit. In some embodiments, the fluorescent repeating unit is derived from a monomeric diol configured to be reacted with an isocyanate and/or a diisocyanate to form the polyurethane foam.

In another aspect, a method is provided for making a polyurethane foam having a fluorescent monomeric repeat unit. The method includes contacting a monomeric diol with an isocyanate and/or a diisocyanate under reaction conditions suitable for forming a polyurethane foam, wherein said monomeric diol includes a fluorophore.

In another aspect, a method of authenticating a polyurethane foam is provided. The method includes irradiating the polyurethane foam with ultraviolet and/or visible light; observing or detecting light emission from the polyurethane foam; and ascertaining the authenticity of said polyurethane foam by determining the presence or absence of fluorescence and/or luminescence from the polyurethane foam at a predetermined wavelength.

### BRIEF DESCRIPTION OF THE DRAWINGS

FIG. 1 is an x-ray diffraction (XRD) trace of crystalline, 2′-(7-nitrobenzo[c][1,2,5]oxadiazol-4-ylazanediyl)diethanol as prepared in Example 1.

FIG. 2 is the DSC trace overlay of 4-chloro-7-nitrobenzofurazan and Compound I, according to the examples.

FIG. 3 is the TGA of Compound I, according to the examples.

FIG. 4 is the UV/Vis absorption spectra of 4-chloro-7-nitrobenzofurazan and Compound I, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

As used herein, “alkylene” refers to a straight chain divalent alkyl group having from 2 to about 20 carbon atoms, and typically from 2 to 12 carbons or, in some embodiments, from 2 to 8 carbon atoms. Alkylene groups may be substituted or unsubstituted. Examples of straight chain alkylene groups include methylene, ethylene, n-propylene, n-butylene, n-pentylene, n-hexylene, n-heptylene, and n-octylene groups. Representative substituted alkyl groups may be substituted one or more times with, for example, amino, thio, hydroxy, cyano, alkoxy, and/or halo groups such as F, Cl, Br, and I.

As used herein, “alkenylene” refers to a straight chain divalent alkyl group having from 2 to about 20 carbon atoms, and typically from 2 to 12 carbons or, in some embodiments, from 2 to 8 carbon atoms, and further including at least one double bond. Alkylene groups may be substituted or unsubstituted. Representative substituents include, for example, amino, thio, hydroxy, cyano, alkoxy, and/or halo groups such as F, Cl, Br, and I.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6 to 10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

As used herein, “fluorophore” refers to a fluorescent chemical compound that can re-emit light upon light excitation. Fluorophores typically contain several combined aromatic groups, or plane or cyclic molecules with several conjugated π bonds. Non-limiting examples include phenols, xanthenes (e.g., fluorescein, rhodamine, Oregon green, eosin, and Texas red), cyanines (e.g., cyanine, indocarbocyanine, oxacarbocyanine, thiacarbocyanine, and merocyanine), naphthalenes (e.g., dansyl and prodan derivatives), coumarins, oxadiazoles (e.g., pyridyloxazole, nitrobenzoxadiazole and benzoxadiazole), pyrenes (e.g., cascade blue), oxazines (e.g., Nile red, Nile blue, cresyl violet, and oxazine 170), acridines (e.g., proflavin, acridine orange, and acridine yellow), arylmethines (e.g., auramine, crystal violet, and malachite green), tetrapyrroles (e.g., porphin, phtalocyanine, and bilirubin), and benzofurazans (e.g., benzo[c][1,2,5]oxadiazole and 4-nitrobenzo[c][1,2,5]oxadiazole). Fluorophores, as used herein for the preparation of the monomeric diols, can be purchased from commercial sources (e.g., Life Technologies, New York, USA) or synthesized by methods known in the art.

As used herein, “polyurethane” refers to a polymer composed of a chain of organic units joined by carbamate (urethane) links Polyurethanes are formed by reacting a monomer having two or more isocyanate (—N═C═O) groups with a monomer having two or more hydroxyl (—OH) groups.

As used herein, “monomeric diol” refers to a compound having at least two hydroxyl groups and a fluorophore.

As used herein, “isocyanate” refers to a compound having an —N═C═O group, while “diisocyanate” refers to a compound having two or more such groups. Exemplary diisocyanates for use in the methods and foam described herein include methylene diphenyl diisocyanate (MDI), hexamethylene diisocyanate (HDI), toluene diisocyanate (TDI), isophorone diisocyanate (IPDI), methylene bis-cyclohexyldiisocyanate (HMDI), and naphthalene diisocyanate (NDI). One or more isocyanates or diisocyanates (e.g., aromatic, aliphatic, cycloalkyl) can be used in differing amounts. Isocyanates and diisocyanates may be used in polyurethane foams. Isocyanates may be used as end caps on a polyurethane, while diisocyanates may be used as propagating repeat units of the polyurethane.

In one aspect, provided is a polyurethane foam including a fluorescent repeating unit. In certain embodiments, the fluorescent repeating unit is derived from a monomeric diol configured to be reacted with an isocyanate and/or a diisocyanate to form the polyurethane foam.

In certain embodiments, the fluorescent repeating unit is introduced into the foam via a monomeric diol comprising a fluorophore. Although it is contemplated that any fluorophore can be used in the polyurethane foams described herein, some exemplary fluorophores include phenols, xanthenes, cyanines, naphthalenes, coumarins, oxadiazoles, pyrenes, oxazines, acridines, arylmethines, tetrapyrroles, and benzofurazans. In one embodiment, the fluorophore is a benzofurazan.

In one embodiment, the monomeric diol is a compound of Formula I:

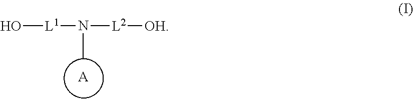

In Formula I, A is a fluorophore; and L¹ and L² are each independently C₂-C₂₀ alkylene, C₂-C₁₀ alkylene-O—C₂-C₁₀ alkylene, or C₂-C₁₀ alkylene-NH—C₂-C₁₀ alkylene, wherein each alkylene is independently optionally substituted with halo, alkyl, cycloalkyl, or aryl.

In another embodiment, the monomeric diol is a compound of Formula II:

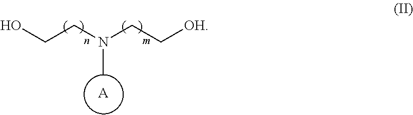

In Formula II, A is a fluorophore; and n and m are each independently an integer from 1 to 20.

In yet another embodiment, the monomeric diol is a compound of Formula III:

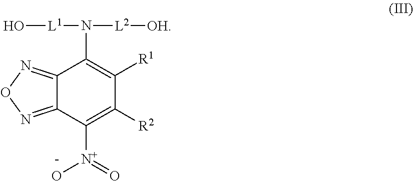

In Formula III, L¹ and L² are each independently C₂-C₂₀ alkylene, C₂-C₁₀ alkylene-O—C₂-C₁₀ alkylene, or C₂-C₁₀ alkylene-NH—C₂-C₁₀ alkylene, wherein each alkylene is independently optionally substituted with halo, alkyl, cycloalkyl, or aryl; and R¹ and R² are individually hydrogen, halo, cyano, alkyl, cycloalkyl, or aryl.

In one embodiment, the monomeric diol is 2,2′-(7-nitrobenzo[c][1,2,5]oxadiazol-4-ylazanediyl)diethanol.

The polyurethane foam includes a monomeric diol, which, in turn includes a fluorophore. The polyurethane foam also includes one or more additional diols and/or polyols (i.e., compounds having two or more hydroxyl moieties). In some embodiments, the additional diol is an alkylene diol, or alkenylene diol, such as ethylene glycol, propylene glycol, butane-1,4-diol, a polydiene diol (e.g., hydroxyl-terminated polybutadiene (HTPB)), or the like. In some embodiments, the additional diol is a polyether, such as polyethylene glycol, polypropylene glycol, poly(tetramethylene ether) glycol (PTMEG), and the like. In some embodiments, the polyurethane foam further includes a polyol having two or more hydroxyl groups. Illustrative polyols that may be used in the polyurethane foam include, but are not limited to, glycerin and glycerin derivatives and polyether polyols, such as those derived from ethylene oxide and/or propylene oxide. In one embodiment, the additional diol is polypropylene glycol pentaerythritol ether (Pluracol® 2010).

The monomeric diol may be present in the polyurethane foam in a concentration of greater than about 1 ppm. In some embodiments, the monomeric diol is present in a concentration of greater than about 2 ppm, or greater than about 5 ppm, or greater than about 10 ppm, or greater than about 20 ppm, or greater than about 50 ppm, or greater than about 100 ppm, or greater than about 200 ppm, or greater than about 500 ppm, or greater than about 1000 ppm. In some embodiments, the monomeric diol is present in a concentration of less than about 1 ppm, less than about 2 ppm, or less than about 5 ppm, or less than about 10 ppm, or less than about 20 ppm, or less than about 50 ppm, or less than about 100 ppm, or less than about 200 ppm, or less than about 500 ppm, or less than about 1000 ppm. In some embodiments, the monomeric diol is present in a concentration of from about 50 ppm to about 500 ppm, or from about 100 ppm to about 300 ppm.

The polyurethane foam is synthesized by contacting a suitable diol, or polyol, with an isocyanate and/or a diisocyanate. Accordingly, in one embodiment, provided is a method for making a polyurethane foam including a fluorescent repeating unit. The method includes contacting a monomeric diol as described herein with an isocyanate and/or a diisocyanate under reaction conditions suitable for forming a polyurethane foam, wherein said monomeric diol includes a fluorophore.

It is contemplated that any isocyanate and/or diisocyanate can be used in the methods and foam described herein. For example, in one embodiment the isocyanate and/or diisocyanate is of formula IV:

O═C═N-J¹-R³-J²-N═C═O (IV).

In Formula I, each of J¹ and J² are independently a bond, alkylene, alkenylene, cycloalkylene or arylene, and R³ is alkylene, cycloalkylene, or arylene, wherein each alkylene, cycloalkylene, or arylene is optionally substituted with halo, cyano, alkyl, cycloalkyl, or aryl.

Exemplary diisocyanates for use in the methods and foam described herein include methylene diphenyl diisocyanate (MDI), hexamethylene diisocyanate (HDI), toluene diisocyanate (TDI), isophorone diisocyanate (IPDI), methylene bis-cyclohexyldiisocyanate (HMDI), and naphthalene diisocyanate (NDI). One or more isocyanates or diisocyanates (e.g., aromatic, aliphatic, cycloalkyl) can be used in differing amounts.

The polyurethane foam is produced by mixing two or more liquid streams, one including the isocyanate and/or diisocyanate and the other including the monomeric diol. The isocyanate and/or a diisocyanate is typically added alone and the monomeric diol is typically added as a solution including one or more additional agents. Such illustrative additional agents may include, but are not limited to catalysts, additional diols, additional polyols, and blowing agents.

In polyurethane chemistry, the blowing agent may be an added gas such as nitrogen, oxygen, or carbon dioxide, or the blowing agent may be generated from the isocyanate and/or diisocyanate by the addition of water, which will react with the isocyanate to form carbon dioxide gas. Accordingly, in some embodiments, the method further comprises water.

In one embodiment, the polyurethane foam also includes one or more additional diols and/or polyols. In some embodiments, the additional diol is an alkylene diol or an alkenylene diol. Illustrative additional diols include, but are not limited to, ethylene glycol, propylene glycol, butane-1,4-diol, polydiene diols (e.g., hydroxyl-terminated polybutadiene (HTPB)), and polyethers, such as polyethylene glycol, polypropylene glycol, or poly(tetramethylene ether) glycol (PTMEG). Illustrative polyols that may be used in the polyurethane foam include, but are not limited to, glycerin and glycerin derivatives and polyether polyols, such as those derived from ethylene oxide and/or propylene oxide. In one embodiment, the additional diol is polypropylene glycol pentaerythritol ether (Pluracol® 2010).

In another embodiment, the polyurethane foam is a rigid polyurethane foam. Accordingly, in some embodiments, one or more polyols (i.e., compounds having three or more hydroxyl moieties) is used to provide the polyurethane foam. In some embodiments, the polyurethane foam also includes a polyol having two or more hydroxyl groups. Exemplary polyols which can be used in the polyurethane foam described herein include, but are not limited to, glycerin and glycerin derivatives.

In one embodiment, the polyurethane foam is a flexible polyurethane foam. In such cases, the method of preparing the polyurethane foam further includes adding water to the isocyanate and/or diisocyanate and the diol.

Typically, the ratio of total hydroxyl groups (from the monomeric diol and any additional diol and/or polyol) to NCO group(s) of the isocyanate and/or diisocyanate is from about 0.85:1 to about 1.50:1, or from about 0.95:1 to 1.15:1, or from about 0.9:1 to about 1.1:1.

In one embodiment, a catalyst is added to facilitate the reaction. Illustrative catalysts include, but are not limited to a tertiary amine, such as triethylenediamine (TEDA, 1,4-diazabicyclo[2.2.2]octane (DABCO), dimethylcyclohexylamine (DMCHA), or dimethylethanolamine (DMEA), or a metallic compound based on mercury, lead, tin, bismuth, or zinc.

Additional auxiliary reagents and/or additives may be found in the literature. For example, J. H. Saunders and K. C. Frisch High Polymers, Volume XVI, Polyurethanes, part 1 and 2, Interscience Publishers 1962 or 1964, or Kunststoff-Handbuch, Polyurethane, Volume VII, Carl-Hanser-Verlag, Munich, Vienna, 1st and 2nd Editions, 1966 and 1983.

Fraudulent warranty claims may cause companies to incur substantial financial losses. In the polyurethane foam industry, fraudulent warranty claims occur when a polyurethane foam fails, and the foam, although bearing all the hallmarks of a given polyurethane supplier was not made by the given supplier. In other words, an unknown polyurethane foam producer has made a polyurethane foam that by all outward appearances is that of another more prominent branded polyurethane foam producer. When the foam fails, it is the branded polyurethane foam producer that is then contacted to fulfill the warranty. Such polyurethane foams are typically used in residential and commercial construction. To address such issues, a method is provided for authenticating a polyurethane by using polyurethanes that incorporate a fluorophore. Such methods may be used to authenticate any type of polyurethane, such as security inks and/or adhesives for joint failures. In some embodiments, the polyurethane is a polyurethane foam.

The method may include irradiating a polyurethane with ultraviolet and/or visible light, observing a characteristic emission from the polyurethane; and ascertaining the authenticity of said polyurethane foam by determining the presence or absence of fluorescence and/or luminescence from the polyurethane foam at a predetermined wavelength.

In one embodiment, the polyurethane foam is authentic if the polyurethane foam is fluorescent and/or luminescent. For example, depending upon the fluorophore that is incorporated into the polyurethane the fluorescence or luminescence may be activated at a specific wavelength or range of wavelengths and not across broad wavelength ranges.

In one embodiment, the predetermined wavelength is from about 400 to about 700 nm. In one embodiment, the predetermined wavelength is from about 400 to about 550 nm.

The present invention, thus generally described, will be understood more readily by reference to the following examples, which are provided by way of illustration and are not intended to be limiting of the present invention.

### EXAMPLES

### Example 1

### Synthesis of 2,2′-(7-nitrobenzo[c][1,2,5]oxadiazol-4-ylazanediyl)diethanol (Compound I)

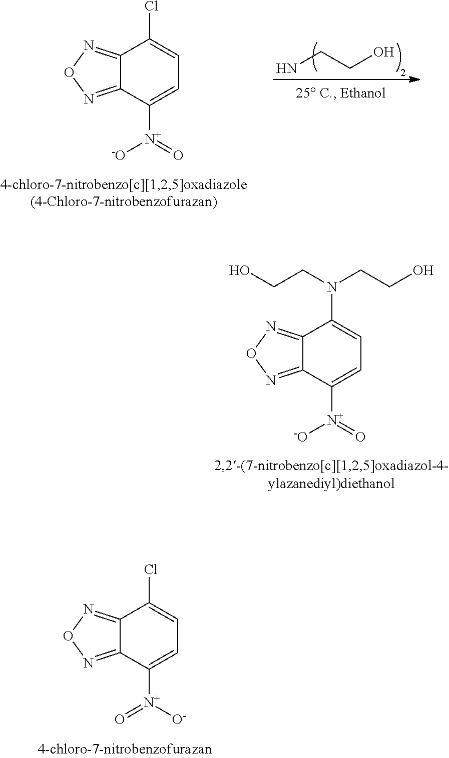

4-Chloro-7-nitrobenzofurazan, diethanol amine, and pure ethanol were purchased from Sigma Aldrich. Ethanol and 4-chloro-7-nitrobenzofurazan were charged to a 2 L flask and agitated. Diethanol amine was then added at room temperature and allowed to mix for several hours. The resultant solidified product was dissolved in a 70/30 blend of ethanol and deionized water and heated to 70° C. to resolubilize the product. Once the temperature was reached, the product dissolved and heat was removed to recrystallize the pure product. The solvent was poured off and the crystalline product was collected, washed and dried. ¹H NMR (d6-DMSO) 8.45 (d), 6.56 (d), 5.02 (t), 3.77 (q), 3.35 (s).

Characterization of the product of Example 1. The crystals of the product of Example 1 were analyzed via SEM, polarized light microscopy and X-ray diffraction (XRD). Functional groups were determined using the Bio Rad Fourier Transform Infrared (FTlR) FTS 6000 Spectrometer. Structure determination was carried out using Proton and carbon NMR. Melting point was measured using the TA Instruments DSC Q2000 with a heating rate of 15° C. minute. Thermal stability was measured using TA instruments. The crystal structure was verified through several analytical tools; the Olympus BH2 UMA Polarized Light Microscope by Leads Precision Instruments. Crystals were also confirmed using the Zeiss EVO MA15 Scanning Electron Microscope (SEM) and through X-ray diffraction using the Rigaku RU 200B diffractometer.

The product was a wet powdery material when filtered. However, upon recrystallization the pure crystalline material was collected and analyzed.

The starting material, 4-chloro-7-nitrobenzofurazan, a yellow powdery solid transformed into red crystals as a result of the reaction. The crystals were then analyzed through several analytical techniques. First, the crystals were submitted for SEM analysis. The images collected show nice crystalline structures in the product mostly reminiscent of triclinic morphology. A triclinic structure is one in which none of the angles are equal to 90°. The starting material lacks any visible crystal structure. In addition to collecting images, the SEM is capable of energy dispersive spectroscopy (EDS). This allows for elemental analysis of samples relying on X-ray excitation. Each element has an inimitable atomic structure which emits unique peaks on its corresponding X-ray spectrum. Atoms have ground state electrons that when excited will eject leaving a hole that is filled by an electron in a higher energy shell. The difference in energy between the two is released in the form of X-rays and the EDS detector measures the number and energy of these X-rays. As each energy difference between shells is specific to the atomic structure in which they were released, the elemental make up can be assigned. The EDS analysis of these crystals shows residual chloride from the reaction. It is reasonable to say that at least some amount of the HCl salt could be generated. SEM-EDS is not however, quantitative and could have margin of errors up to ±30%. Trace levels of chloride in the product were measured to 1.36 weight percent.

The crystals were also analyzed using polarized light microscopy. This method transmits light that is blocked with a polarizer orientated at 90° to the light source. Direct light (white light) will not make it to the detector and will show as dark spots on the image. Polarized light microscopy is widely used in optical mineralogy due to ability to provide information on absorption color and confines of an optical path between minerals with varying refractive indices. The signal that reaches the detector arises from a substance capable of bending light that will take the form of an image representative of the substance being analyzed.

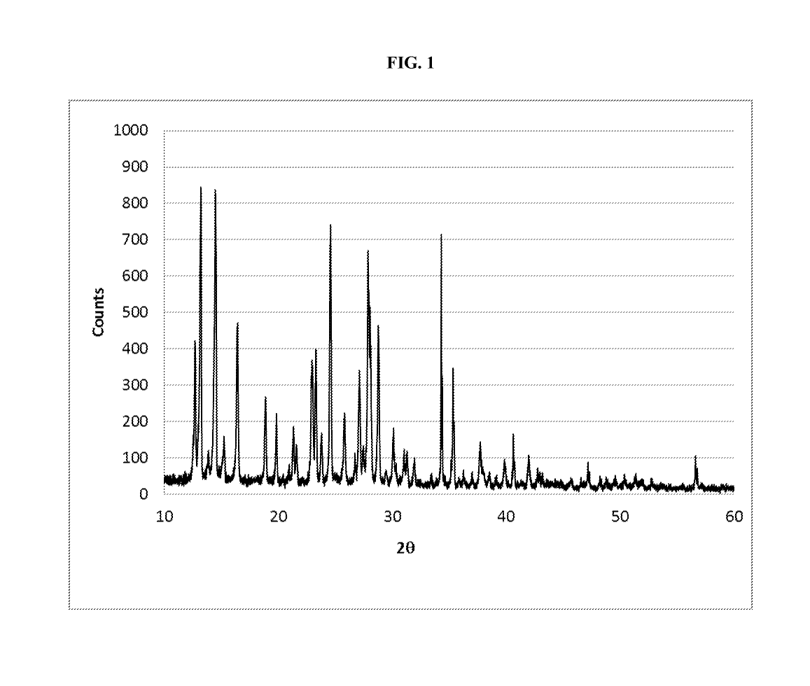

XRD was measured on the crystals to further verify the crystalline nature of the solid, as evidenced by the high counts in the low angle range of Bragg reflections. An Illustration of the XRD is shown in FIG. 1.

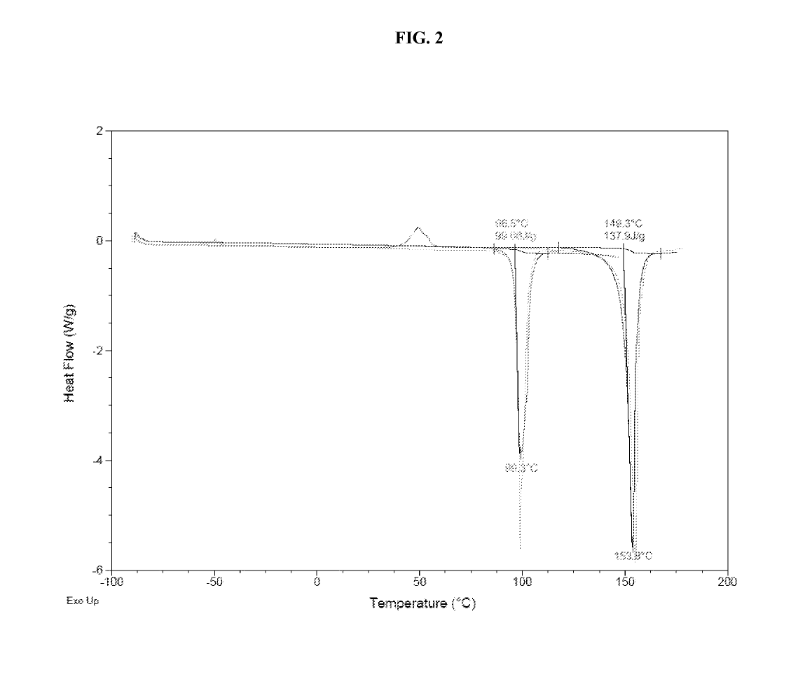

Thermal analysis showed a marked difference between melting points in the 4-chloro-7-nitrobenzo furazan starting material and the crystalline Compound I. The starting material had a melting point of 99.3° C. requiring 99.6 J/g with a cold crystallization around 48° C. The melting point of Compound I was 153.8° C. requiring 137.9 J/g and lacked cold crystallization. It is contemplated that the increase is most likely a reflection of the hydrogen bonding contributions from the hydroxyl moieties. See FIG. 2 for DSC trace overlay. 4-Chloro-7-Nitrobenzofurazan lacked any visible crystal characteristics. However, the DSC trace shows a sharp melting point which is indicative of crystalline materials. It is contemplated that 4-chloro-7-nitrobenzofurazan has such a fine crystal structure that the SEM was not sensitive enough to detect a packing structure.

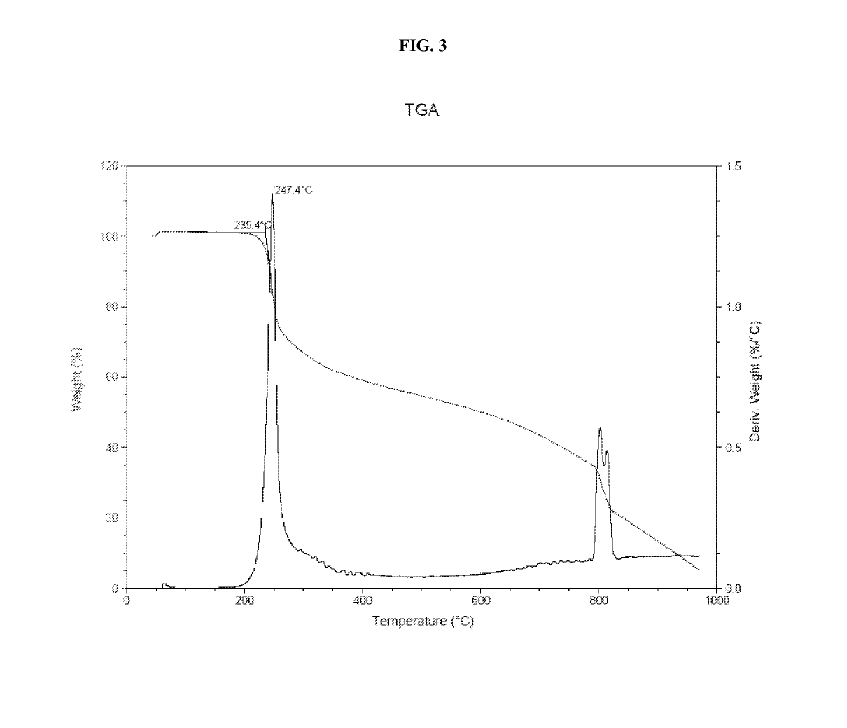

Thermal degradation analysis (TGA) shows Compound I to be relatively stable at temperatures up to 247° C. (FIG. 3). This is information can be used to determine the types of processing conditions this product can be exposed to. For example, exhibiting stability up to high temperatures allows this material to be used in polyester synthesis, solvent borne baking systems and possibly powder coatings.

The infrared spectra shows several differences between the starting material and Compound I. The first salient difference is in the higher frequencies associated with the addition of the hydroxyl moieties of Compound I. In addition, several other new bands appear at lower vibrations under 1600 cm⁻¹.

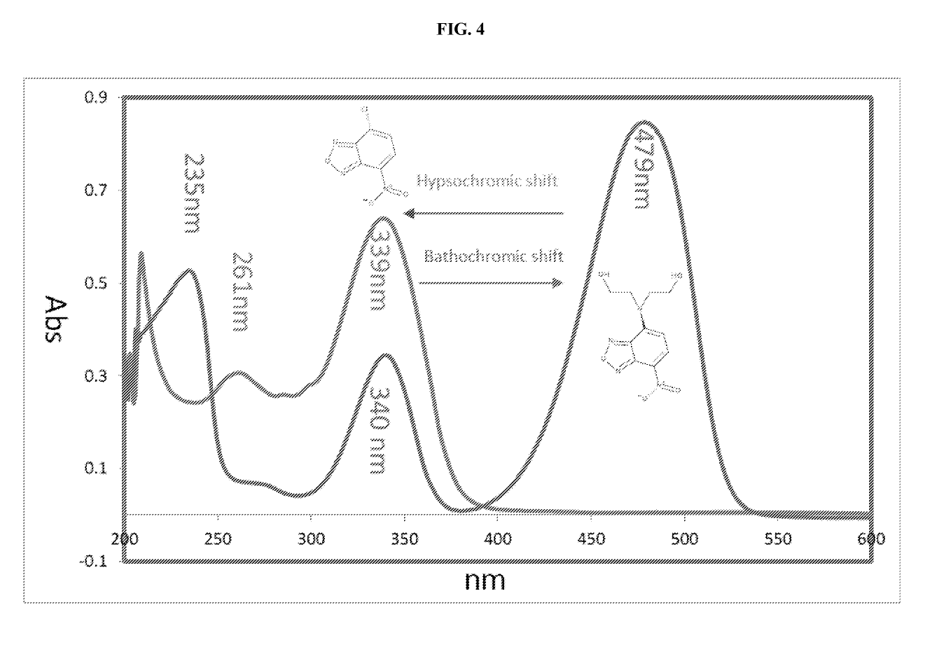

The 4-Chloro-7-Nitrobenzo furazan and Compound I were diluted in THF and absorption spectra were measured. The hypsochromic parent compound was bathochromically shifted as a result of the reaction (FIG. 4). A hypsochromic shift would be considered a “blue” shift, meaning a response at shorter wavelengths (higher frequency). A bathochromic shift conversely, is considered a “red” shift and gives a response at longer wavelengths (shorter frequency). By substituting the Cl atom, an electron withdrawing substituent in the parent compound with an electron donating substituent (i.e. diethanol amine), the molecule is bathochromically shifted.

The bulk crystals were placed in a dark room along with a thinner sample and a dilute solution in acetone. Under backlight conditions, Compound I goes from fluorescent orange in bulk to fluorescent yellow under dilute conditions.

### Example 2

### Polyurethane Foams Containing the Compound of Example 1

In a foaming cup, 2,2′-(7-nitrobenzo[c][1,2,5]oxadiazol-4-ylazanediyl)diethanol was combined with PMDI and a sufficient amount of Pluracol® 2010 to dilute the 2,2′-(7-nitrobenzo[c][1,2,5]oxadiazol-4-ylazanediyl)diethanol in the system to 219 ppm. Water was added to cause foaming. The components were mixed at room temperature and the reaction took place within several minutes.

The polyurethane foam was tested alongside the a similarly produced polyurethane, but without the 2,2′-(7-nitrobenzo[c][1,2,5]oxadiazol-4-ylazanediyl)diethanol. It is apparent that the polyurethane containing the fluorescent diol had an influence on the color of the foam under ambient lighting in that the foam appeared to be a bright yellow.

However, under a black light, while the normal polyurethane did not exhibit any fluorescent or luminescent behavior, the polyurethane with the fluorescent diol did exhibit fluorescence and luminescence.

Levels of Compound I as low as 50 ppm or lower will provide polyurethane foam of the same color of control foam (i.e., foam without Compound I) while still providing a photo-response under black light. Based on the structure of the monomeric diol (i.e., the fluorophore) it is contemplated that fluorescent polyesters, acrylic polyols and/or polyurethane dispersions (PUDs) can also be provided using Compound I.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A polyurethane foam comprising a fluorescent repeating unit.

2. The polyurethane foam of claim 1, wherein the fluorescent repeating unit is derived from a monomeric diol configured to be reacted with an isocyanate and/or a diisocyanate to form the polyurethane foam.

3. The polyurethane foam of claim 2, wherein the monomeric diol comprises a fluorophore selected from the group consisting of a phenol, xanthene, cyanine, naphthalene, coumarin, oxadiazole, pyrene, oxazine, acridine, arylmethine, tetrapyrrole, and benzofurazan.

4. The polyurethane foam of claim 2, wherein the monomeric diol is a compound of formula (I): 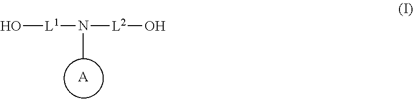
wherein:
A is a fluorophore; and
L¹ and L² are each independently C₂-C₂₀ alkylene, C₂-C₁₀ alkylene-O—C₂-C₁₀ alkylene, or C₂-C₁₀ alkylene-NH—C₂-C₁₀ alkylene, wherein each alkylene is independently optionally substituted with halo, alkyl, cycloalkyl, or aryl.

5. The polyurethane foam of claim 2, wherein the monomeric diol is a compound of formula (II): 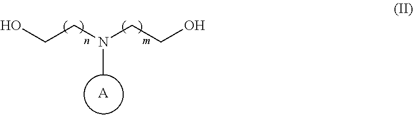
wherein:
A is a fluorophore; and
n and m are each independently an integer from 1 to 20.

6. The polyurethane foam of claim 2, wherein the monomeric diol is a compound of formula (III): 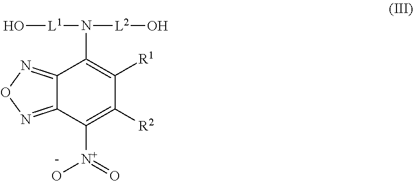
wherein:
L¹ and L² are each independently C₂-C₂₀ alkylene, C₂-C₁₀ alkylene-O—C₂-C₁₀ alkylene, or C₂-C₁₀ alkylene-NH—C₂-C₁₀ alkylene, wherein each alkylene is independently optionally substituted with halo, alkyl, cycloalkyl, or aryl; and
R¹ and R² are individually hydrogen, halo, cyano, alkyl, cycloalkyl, or aryl.

7. The polyurethane foam of claim 2, wherein the monomeric diol is 2,2′-(7-nitrobenzo[c][1,2,5]oxadiazol-4-ylazanediyl)diethanol.

8. The polyurethane foam of claim 1, wherein the monomeric diol is present in a concentration of about 1 ppm to about 1000 ppm.

9. A method for making a polyurethane foam, the method comprising contacting a monomeric diol with an isocyanate, a diisocyanate, or both an isocyanate and a diisocyanate under reaction conditions suitable for forming the polyurethane foam, wherein said monomeric diol comprises a fluorophore.

10. The method of claim 9, wherein the reaction conditions further comprise a polyol.

11. The method of claim 10, wherein the polyol is polypropylene glycol pentaerythritol ether.

12. The method of claim 9, wherein the monomeric diol is a compound of formula (I) 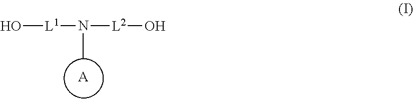
wherein:
A is a fluorophore; and
L¹ and L² are each independently C₂-C₂₀ alkylene, C₂-C₁₀ alkylene-O—C₂-C₁₀ alkylene, or C₂-C₁₀ alkylene-NH—C₂-C₁₀ alkylene, wherein each alkylene is independently optionally substituted with halo, alkyl, cycloalkyl, or aryl.

13. The method of claim 9, wherein the monomeric diol is 2,2′-(7-nitrobenzo[c][1,2,5]oxadiazol-4-ylazanediyl)diethanol.

14. The method of claim 9, wherein the isocyanate and/or diisocyanate is selected from the group consisting of diphenyl diisocyanate (MDI), hexamethylene diisocyanate (HDI), toluene diisocyanate (TDI), isophorone diisocyanate (IPDI), methylene bis-cyclohexylisocyanate (HMDI), and naphthalene diisocyanate (NDI).

15-16. (canceled)

17. A method of authenticating a polyurethane foam, the method comprising:
irradiating the polyurethane foam with ultraviolet and/or visible light;
observing or detecting light emission from the polyurethane foam; and
ascertaining the authenticity of said polyurethane foam by determining the presence or absence of fluorescence and/or luminescence from the polyurethane foam at a predetermined wavelength.

18. The method of claim 17, wherein the polyurethane foam is authentic if the polyurethane foam is fluorescent and/or luminescent.

19. The method of claim 17, wherein the predetermined wavelength is from about 400 to about 550 nm.

20. The method of claim 17, wherein the fluorescent repeating unit is derived from a monomeric diol configured to be reacted with an isocyanate and/or a diisocyanate to form the polyurethane foam.

21. The method of claim 20, wherein the monomeric diol comprises a fluorophore selected from the group consisting of a phenol, xanthene, cyanine, naphthalene, coumarin, oxadiazole, pyrene, oxazine, acridine, arylmethine, tetrapyrrole, and benzofurazan.

22. The method of claim 20, wherein the monomeric diol is a compound of formula (I): 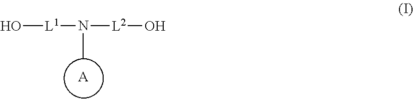
wherein:
A is a fluorophore; and
L¹ and L² are each independently C₂-C₂₀ alkylene, C₂-C₁₀ alkylene-O—C₂-C₁₀ alkylene, or C₂-C₁₀ alkylene-NH—C₂-C₁₀ alkylene, wherein each alkylene is independently optionally substituted with halo, alkyl, cycloalkyl, or aryl.

23-25. (canceled)
